(19) United States
(12) Patent Application Publication
(10) Pub. No.: US 2025/0003821 A1
(43) Pub. Date: Jan. 2, 2025

(54) MEASURING DEVICE, DEVICE FOR LIMITING FLUID FLOW AND DEVICE FOR MEASURING A PROPERTY OF A PROCESS FLUID

(71) Applicant: GEMÜ Gebr. Müller Apparatebau GmbH & Co. Kommanditgesellschaft, Ingelfingen (DE)

(72) Inventors: Martin Rupp, Mulfingen (DE); Johann Magej, Schwäbisch Hall (DE)

(21) Appl. No.: 18/708,969

(22) PCT Filed: Jun. 8, 2022
(86) PCT No.: PCT/EP2022/065546

§ 371 Date: May 9, 2024

(30) Foreign Application Priority Data
Nov. 18, 2021 (DE) 10 2021 130 134.3

(51) Int. Cl. G01L 19/00; G01K 1/14; G01K 13/02; G01L 19/14

(52) U.S. Cl. CPC G01L 19/0046; G01K 1/14; G01K 13/02; G01L 19/14

(57) ABSTRACT

The invention describes a device (100) for adjusting a volumetric flow of a process fluid. Said device comprises a valve arrangement (400), which is designed to adjust, by means of a drive (402), in particular by means of an electric motor, a position of a shut-off body (442), which interacts with a valve seat (142), within an adjusting portion (140) of the fluid duct (102) depending on an activation signal (S #400). A control device (500) is designed to determine the activation signal (S #400) depending on a first and a second sensor signal (S #200, S #300).

The invention relates to advances in the field of process fluid technology.

The problems of the prior art are resolved by a measuring device according to claim 1, by a device for 30 limiting volumetric flow, and by a device for separating media according to an independent claim.

One aspect of the description relates to the following subject matter: A measuring device comprising: a shell body having an opening which leads into a fluid chamber of the measuring device, and having a sealing portion surrounding the opening; an interface which is designed to be supported on a cooperating interface of a body which is designed for providing process fluid, and to press the sealing portion of the 35 shell body against a cooperating sealing portion of the body; a measuring diaphragm which separates the fluid chamber from a measurement chamber of the measuring device; and a sensor device arranged at least partially within the measurement chamber, comprising a sensor which rests against the measuring diaphragm, wherein the sensor device is configured to provide a signal representing a property of the process fluid in the fluid chamber.

The sealing portion of the shell body, together with the cooperating sealing portion, creates a hard/hard sealing connection. Furthermore, the function of the sensor is decoupled from the material properties of the sensor, since only the measuring diaphragm and the fluid chamber are contacted by the medium. The choice of material and sensor design are thus advantageously decoupled from one another, creating corresponding degrees of freedom for the design.

By separating the measuring device from the body carrying the process fluid, a modular system is created, since the measuring device can be connected in a pre-calibrated state to differently designed bodies which have a corresponding cooperating interface and a cooperating sealing portion which surrounds a measuring opening. Accordingly, the design of the corresponding body is structurally decoupled from the requirements for a pressure measurement close to the fluid duct.

This results in degrees of freedom in the design of the bodies, and new applications arise for the measuring device. Advantageously, a separation of the process fluid from the sensor and its measuring surface is achieved. Particle incorporations into the process fluid and contamination of the process fluid are prevented by the measuring device, since the material of the fluid chamber can be selected by providing the measuring diaphragm independently of the materials present in the measurement chamber.

Advantages result from the fact that the measuring device comprises: a clamping means which is supported on the shell body and which presses the sensor against the measuring diaphragm. The clamping means advantageously rigidly fixes the sensor within the measurement chamber.

For example, it is advantageous that an elastic element is arranged in a force path between the clamping means and the measuring diaphragm, in particular between the clamping means and the sensor, and is under pressure. Advantageously, flow processes of the material and different temperature expansions can be compensated for by the elastic element, and the clamping and sealing effect is maintained.

Advantages result from the fact that a particularly rigid positioning piece fills the volume of an inner contour of the measurement chamber perpendicular to the central longitudinal axis, and rests against an outer contour of the sensor facing away from the measuring diaphragm. Advantageously, the sensor and its sensing surface are accordingly centered relative to the measuring diaphragm. In addition, the centering and/or positioning of the sensor is decoupled from the location of the measurement.

Advantages are achieved by the fact that the positioning piece is arranged between the clamping means and the sensor. It is advantageous, for example, that the elastic element is arranged between the clamping means and the positioning piece.

Advantages are achieved by the fact that the measuring diaphragm and the opening of the shell body leading into the fluid chamber are spaced apart from one another along a central longitudinal axis of the shell body, in particular by least a quarter of the diameter of the opening.

Advantageously, the spacing achieves a decoupling of the two regions, and an influence of temperature and material flow under pressure from one region to the other is reduced. The sealing effect can be maintained longer, and the measurement precision can also be maintained.

For example, it is advantageous that the measuring diaphragm and the shell body are integrally connected to one another. The integral design improves the seal tightness between fluid chamber and measurement chamber. In the same way, the contact pressure of the sensor on the measuring diaphragm can be reduced.

For example, it is advantageous that a diaphragm element separate from the shell body comprises the measuring diaphragm, wherein the diaphragm element comprises a sealing portion which is pressed against a cooperating sealing portion of the shell body by means of a clamping force applied by the clamping element.

It is advantageous that a diaphragm element separate from the shell body comprises the measuring diaphragm, wherein the diaphragm element comprises a sealing portion with a contact surface which is pressed against a cooperating sealing portion of the shell body by means of a clamping force applied by the clamping piece. Advantageously, a sealing effect between the fluid chamber and the measurement chamber can be improved by the separately-constructed diaphragm element.

It is advantageous, for example, that a contact surface of the shell body, for contacting an outer contact surface of the sensor, surrounds a measuring surface of the measuring diaphragm for contacting an inner measuring surface of the sensor, wherein the contact surface and the measuring surface lie in the same imaginary plane. Advantageously, a sensor designed with a flat diaphragm can be used.

It is advantageous that the sealing portion of the diaphragm element and the measuring diaphragm of the diaphragm element are spaced apart from one another along the central longitudinal axis of the shell body. The spacing ensures that an influence of temperature-related material expansions and pressure-induced material flows does not have a disadvantageous effect on the sealing effect and function of the measuring diaphragm.

For example, it is advantageous that the sealing portion of the diaphragm element substantially follows an imaginary continuation of the measuring diaphragm. The diaphragm element is thus substantially flat.

For example, it is advantageous that the sealing portion of the diaphragm element runs perpendicular to the central longitudinal axis of the shell body. Advantageously, a step is provided, and a material flow in the sealing region can be compensated for. The sealing force is further directed into the sealing region in a targeted manner by the frustoconical surface shape.

It is advantageous, for example, that the sealing portion of the diaphragm element follows a frustoconical surface. Advantageously, a sealing region is provided which is designed in the shape of a truncated cone, and directs the clamping forces into a surface running obliquely to the central longitudinal axis, thus distributes the forces. A material flow in the sealing region can be compensated for.

It is advantageous, for example, that an outer portion surrounding the sealing portion runs perpendicular to the central longitudinal axis.

For example, it is advantageous that a cooperating portion of the shell body that is opposite the surrounding portion and surrounds the cooperating sealing portion is spaced apart from the surrounding portion. Furthermore, the sealing force is directed in a targeted manner into the sealing region by the surrounding portion of the diaphragm element.

An advantageous example is characterized in that an outer portion of the shell body surrounding the inner sealing portion tapers in the direction of the inner sealing portion, in particular following a frustoconical surface.

For example, it is advantageous that the sealing portion of the diaphragm element substantially follows an imaginary continuation of the measuring diaphragm. The diaphragm element is thus substantially flat.

It is advantageous, for example, that the sealing portion of the diaphragm element runs perpendicular to the central longitudinal axis of the measuring device.

For example, it is advantageous that the sealing portion of the diaphragm element has a taper or a widening, in particular following a frustoconical surface, at least in portions, in the direction of an opening of the diaphragm element.

Advantageously, there is a sealing region running obliquely to the central longitudinal axis, and the clamping forces are directed into the body in a distributed manner. A material flow in the sealing region can be compensated for.

It is, for example, advantageous that a portion of the diaphragm element arranged radially outside of the sealing portion runs perpendicular to the central longitudinal axis. Advantageously, a step stop is thus provided, and a material flow in the sealing region is compensated for.

For example, it is advantageous that a cooperating portion of the shell body surrounding the cooperating sealing portion is spaced apart from the portion surrounding the sealing portion. Advantageously, the sealing force is selectively directed into the sealing region by the spacing.

For example, it is advantageous that the sealing portion of the diaphragm element and the measuring diaphragm of the diaphragm element are spaced apart from one another along the central longitudinal axis of the shell body.

The spacing ensures that an influence of temperature-related material expansions and pressure-induced material flows does not have a disadvantageous effect on the sealing effect and function of the diaphragm.

For example, it is advantageous that an outer portion surrounding the inner sealing portion tapers in the direction of the inner sealing portion, in particular following a frustoconical surface.

It is advantageous, for example, that the measuring diaphragm, in particular the diaphragm element, and the shell body are produced from the same material, in particular from a polyhalogenated olefin, in particular from a polytetrafluoroethylene (PFTE), and/or a perfluoroalkoxy, PFA. A contamination of the process medium is advantageously prevented by the material.

A further aspect of the description relates to a device, comprising: the measuring device according to the preceding aspect; and the body with a fluid duct arranged therein and at least one—in particular multiple—process fluid connections, wherein a measuring point located in the course of the fluid duct has a measuring opening, wherein the measuring opening is surrounded by a cooperating sealing portion for the sealing portion of the shell body, and wherein the body has a cooperating interface for the interface of the measuring device.

For example, it is advantageous that the shell body and the body delimit a leakage duct at least in portions, which leakage duct leads into an exterior of the device.

A further aspect of the description relates to the following subject matter: A device for adjusting and/or limiting a volumetric flow of a process fluid, comprising a one-piece body with a fluid duct arranged in the body and connecting an inlet and an outlet with each other, wherein the fluid duct comprises a measurement portion which has a cross-sectional reduction in the direction of flow of the process fluid, wherein the fluid duct comprises an adjusting portion arranged after the measurement portion in the direction of flow of the process fluid; a first sensor arranged at a first measuring point of the measurement portion, which is designed to generate a first sensor signal which characterizes a pressure of the process fluid in the region of the first measuring point; a second sensor arranged at a second measuring point of the measurement portion, which is designed to generate a second sensor signal which characterizes a pressure of the process fluid in the region of the second measuring point, wherein the cross-sectional reduction is arranged between the first and the second measuring points; a valve arrangement which is configured to adjust, by means of a drive, in particular by means of an electric motor, a position of a shut-off body interacting witelectric motorh a valve seat, within the adjusting portion of the fluid duct, according to an activation signal; and a control device which is configured to determine the activation signal according to the first and the second sensor signals.

The cross-sectional reduction in the direction of flow simplifies the production of the body, wherein, for example, it can be produced in plastic or metal by machining; or a production by plastic injection molding, with the same geometry and design, is also possible.

Due to the fact that the measurement portion is located in front of the adjusting portion, the pressure of the process fluid can advantageously also be determined when the adjusting portion is closed. Furthermore, turbulence which may arise in the region of the adjusting portion has no negative influence on the pressure measurement. The measurement accuracy is thus advantageously improved.

An advantageous example is characterized in that the measurement portion, in particular between the first measuring point and the second measuring point, is free of measuring bodies.

No additional measuring body, such as a diaphragm, is thus arranged in the region of the measurement portion. This improves the cleanability of the fluid duct, and the fields of application. For example, the device is thus also suitable for highly sterile applications or applications with highly aggressive process media.

An advantageous example is characterized in that the first and the second measuring points are arranged in a region of a primary flow of the process fluid.

Advantageously, the pressure is measured in the primary flow, which improves the accuracy of the pressure determination. On the other hand, a measurement in a bypass is avoided, which advantageously reduces the structural complexity of the body and additionally reduces the required installation space.

An advantageous example is characterized in that an inner wall of a first sub-portion of the measurement portion, which extends in the direction of flow up to the cross-sectional reduction, has a first cross-section along the longitudinal extension of the first sub-portion, with the exception of the first measuring point, wherein an inner wall of a second sub-portion of the measurement portion which adjoins the cross-sectional reduction in the direction of flow has a second cross-section along the longitudinal extension of the second sub-portion, with the exception of the second measuring point.

Advantageously, a laminar flow is generated in the sub-portions, and turbulence is produced mainly by the cross-sectional reduction, which has a positive effect on the measurement accuracy. Moreover, the manufacturability also improves.

An advantageous example is characterized in that the second measuring point is further away from the cross-sectional reduction than the first measuring point.

This advantageously improves the measurement accuracy.

An advantageous example is characterized in that the control device is configured to determine an actual volumetric flow according to the first sensor signal and according to the second sensor signal, and to compare the actual volumetric flow with a target volumetric flow, and to determine the activation signal according to the comparison.

Advantageously, a control loop is provided.

An advantageous example is characterized in that a wireless interface is configured to transmit values of the actual volumetric flow and to receive values for the target volumetric flow.

This accordingly advantageously simplifies, for the plant operator, adjusting the volumetric flow and/or its target value with a tablet or with a similar device close to the system, and reading out further process parameters, such as pressure and temperature.

An advantageous example is characterized in that at least one of the sensors generates a further signal which characterizes a temperature of the process fluid, wherein the activation signal is additionally determined according to the further signal.

Taking the temperature into account makes it possible to use the device for adjusting the volumetric flow of compressible process media. However, even in the case of incompressible media, the viscosity can be deduced from the temperature.

An advantageous example is characterized in that at least one display unit which can be seen from the outside and is configured to display the determined actual volumetric flow.

Advantageously, a visual inspection by the operating personnel can be performed in this way.

An advantageous example is characterized in that at least one of the measuring points has a measuring opening which is surrounded by a contact surface facing away from the fluid duct, wherein a clamping means supported on the body presses the sensor in the direction of the contact surface.

Advantageously, the sensor is fixed to the body in a simple manner by the clamping means.

An advantageous example is characterized in that a measuring diaphragm separates the sensor from a media-conducting region, in particular the fluid duct.

An advantageous example is characterized in that a measuring diaphragm closes off the measuring opening, wherein a clamping force generated by the clamping means supported on the body clamps a lateral portion of the measuring diaphragm between a lateral portion of the sensor and the contact surface.

As a result of the proposed arrangement with the measuring diaphragm, in addition to media separation, it is advantageously achieved that the sensor can be arranged closer to the medium, which improves the measurement, in particular in terms of precision.

Advantageously, a dead space for the process fluid in the region of the measuring point can thus be prevented or at least reduced. Furthermore, degrees of freedom arise for the materials used on the dry side of the measuring diaphragm. For example, a sensor with a measuring surface can be used, the material of which must not have a direct contact with the process fluid.

Furthermore, the service life of the measuring point is increased, since the measuring diaphragm provides a separation of the sensor from the process fluid, and thus slows down its aging process—in particular, in the case of aggressive process media.

An advantageous example is characterized in that an elastic element is arranged between the clamping means and the measuring diaphragm, in particular between the clamping means and the sensor.

The material volume of the clamped elements can change due to aging and temperature differences. The elastic element compensates for the changing material volumes due to its elasticity. Advantageously, the elastic element maintains the clamping of the measuring diaphragm in its lateral region.

An advantageous example is characterized in that a positioning piece is arranged in the force path between the clamping means and the sensor, which positioning piece rests against an outer contour of the sensor facing away from the measuring diaphragm—in particular, accommodates it.

Advantageously, the positioning piece ensures that the sensor is located at the correct position in relation to the measuring diaphragm during installation. In addition, the contact surface on the positioning piece can unambiguously determine the pressing of the elastomer. In addition, the positioning piece allows the use of different sensors, with a corresponding adaptation. Thus, only the positioning piece has to be adapted when the sensor type is changed. The construction of the device is thus decoupled by means of the positioning piece from the sensor type used in each case.

An advantageous example is characterized in that the measuring diaphragm and the body are produced from the same material, in particular from a thermoplastic such as a polyhalogenated olefin, in particular polytetrafluoroethylene (PFTE).

The number of materials contacting the media is advantageously reduced. Consequently, there is no need for further approval procedures.

A further aspect of the description relates to the following subject matter: A device for measuring at least one property of a process fluid, comprising: a body with a fluid duct arranged therein, wherein a measuring point located in the course of the fluid duct has a measuring opening, and wherein the measuring opening is surrounded by a contact surface facing away from a measurement chamber; a sensor arranged at the measuring point, designed to generate a sensor signal which characterizes the property of the process fluid in the region of the measuring point; a measuring diaphragm which closes off the measuring opening; and a clamping means supported on the body, pressing the sensor in the direction of the contact surface and clamping a lateral portion of the measuring diaphragm between the sensor and the contact surface.

As a result of the proposed arrangement with the measuring diaphragm, in addition to media separation, it is advantageously achieved that the sensor can be arranged closer to the medium, which improves the measurement, and in particular its precision.

Advantageously, a dead space for the process fluid in the region of the measuring point can thus be prevented or at least reduced. Furthermore, degrees of freedom arise for the materials used on the dry side of the measuring diaphragm. For example, a sensor with a measuring surface can be used, the material of which must not have a direct contact with the process fluid.

Furthermore, the service life of the measuring point is increased, since the measuring diaphragm provides a separation of the sensor from the process fluid and thus slows down its aging process.

An advantageous example is characterized in that an elastic element is arranged between the clamping means and the measuring diaphragm, in particular between the clamping means and the sensor.

The material volume of the clamped elements can change due to aging and temperature differences. The elastic element compensates for the changing material volumes due to its elasticity. Advantageously, the elastic element maintains the clamping of the measuring diaphragm in its lateral region.

An advantageous example is characterized in that a positioning piece is arranged in the force path between the clamping means and the sensor, which positioning piece rests against an outer contour of the sensor facing away from the measuring diaphragm—in particular, accommodates it.

Advantageously, the positioning piece ensures that the sensor is located at the correct position in relation to the measuring diaphragm during installation. In addition, the positioning piece allows the use of different sensors, with a corresponding adaptation. Thus, only the positioning piece has to be adapted when the sensor type is changed. The construction of the device is thus decoupled by means of the positioning piece from the sensor type used in each case.

An advantageous example is characterized in that the measuring diaphragm and the body are produced from the same material, in particular from a thermoplastic such as a polyhalogenated olefin, in particular polytetrafluoroethylene (PFTE).

The number of materials contacting the media is advantageously reduced. Consequently, there is no need for further approval methods for the use of the device.

It is advantageous that a diaphragm element separate from the body comprises the measuring diaphragm, wherein the diaphragm element comprises a sealing portion with a contact surface which is pressed against a cooperating sealing portion of the body by means of a clamping force applied by the clamping piece. This makes it possible to arrange the sensor or its sensor surface directly on the diaphragm on the dry side. Nevertheless, the diaphragm element and the body can be produced from the same material in order thus to prevent contamination of the process fluid.

For example, it is advantageous that the sealing portion of the diaphragm element substantially follows an imaginary continuation of the measuring diaphragm. The diaphragm element is thus substantially flat.

An advantageous example is characterized in that the sealing portion of the diaphragm element runs perpendicular to the central longitudinal axis of the device.

For example, it is advantageous that the sealing portion of the diaphragm element has, at least in portions, a taper or a widening, and in particular follows a frustoconical surface, in the direction of an opening of the diaphragm element. Advantageously, there is a sealing region running obliquely to the central longitudinal axis, and the clamping forces are directed into the body in a distributed manner. A material flow in the sealing region can be compensated for.

It is advantageous, for example, that an outer portion of the diaphragm element surrounding the sealing portion runs perpendicular to the central longitudinal axis. Advantageously, a step stop is thus provided, and a material flow in the sealing region is compensated for.

For example, it is advantageous that a cooperating portion of the body surrounding the cooperating sealing portion is spaced apart from the portion surrounding the sealing portion. Advantageously, a step is provided, and a material flow in the sealing region can be compensated for. The sealing force is further directed into the sealing region in a targeted manner by the frustoconical surface shape. Furthermore, the sealing force is directed in a targeted manner into the sealing region by the surrounding portion of the diaphragm element.

It is advantageous that the sealing portion of the diaphragm element and the measuring diaphragm of the diaphragm element are spaced apart from one another along a central longitudinal axis of the sensor. The spacing ensures that an influence of temperature-related material expansions and pressure-induced material flows does not have a disadvantageous effect on the sealing effect and function of the diaphragm.

It is, for example, advantageous that an outer portion surrounding the inner sealing portion tapers in the direction of the inner sealing portion, in particular following a frustoconical surface.

In the drawing:

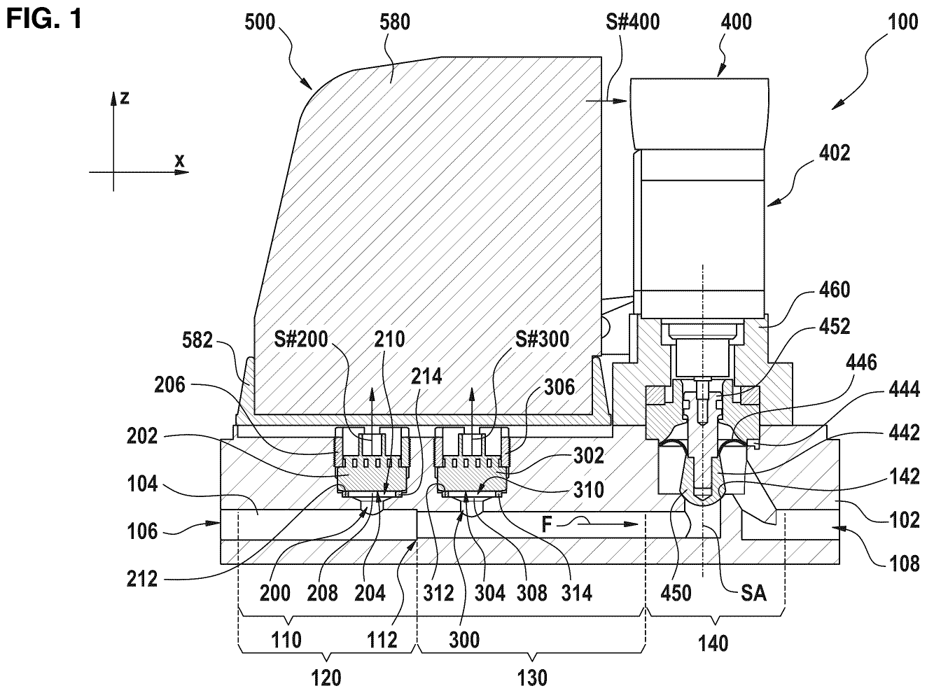

FIG. 1 shows a section through a device for adjusting or regulating a volumetric flow of a process fluid;

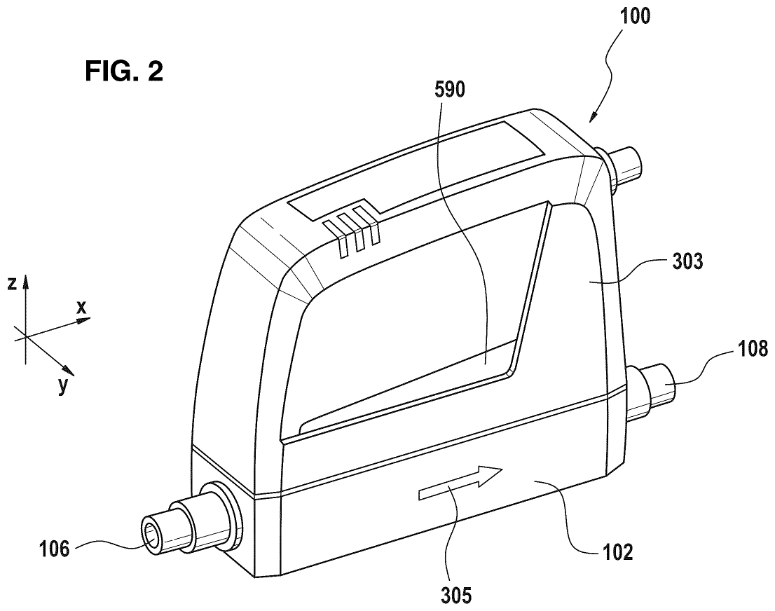

FIG. 2 shows a perspective view of the device of FIG. 1;

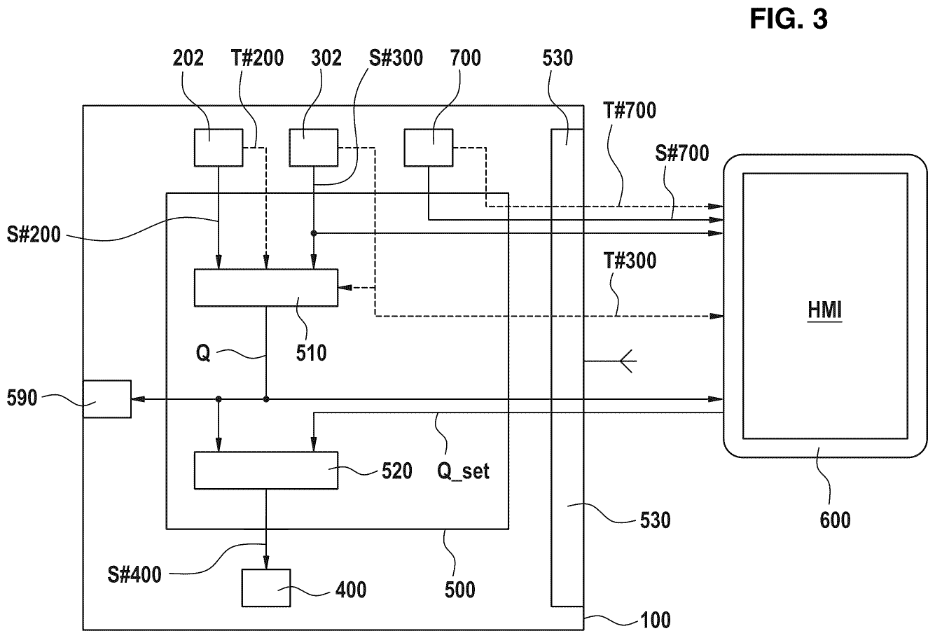

FIG. 3 shows a schematic block diagram of the device, and of an operating device;

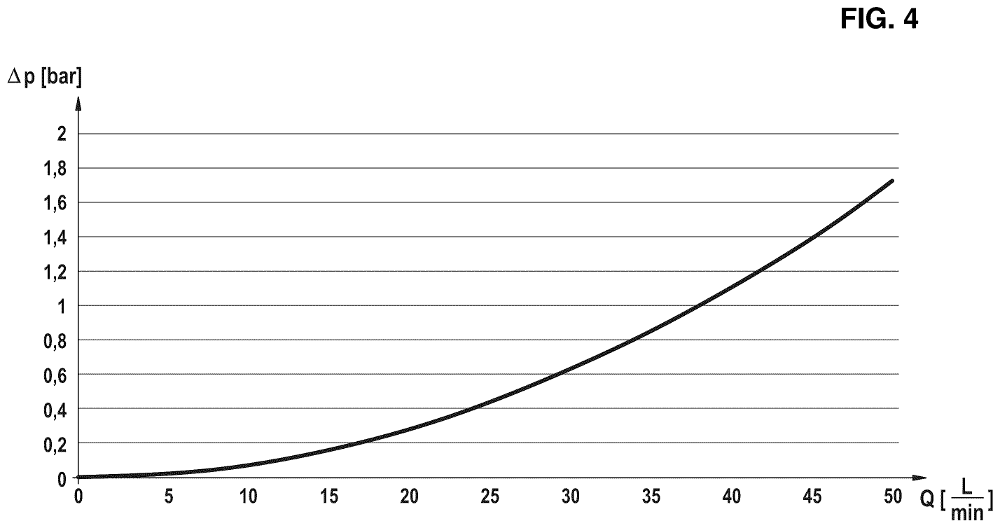

FIG. 4 shows a schematic pressure difference/volumetric flow diagram,

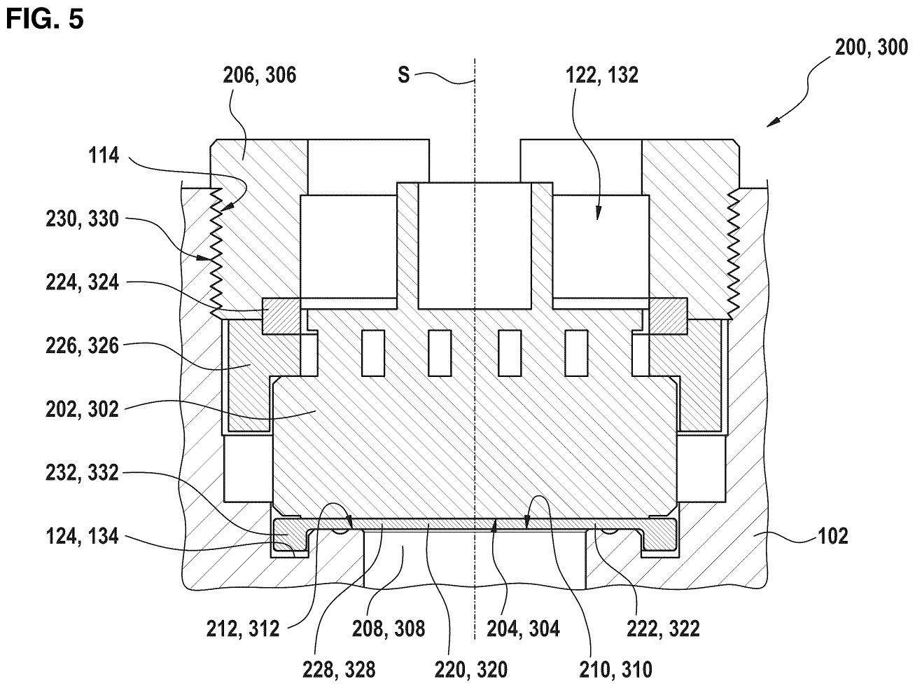

FIG. 5 shows an alternative example of a measuring point of FIG. 1;

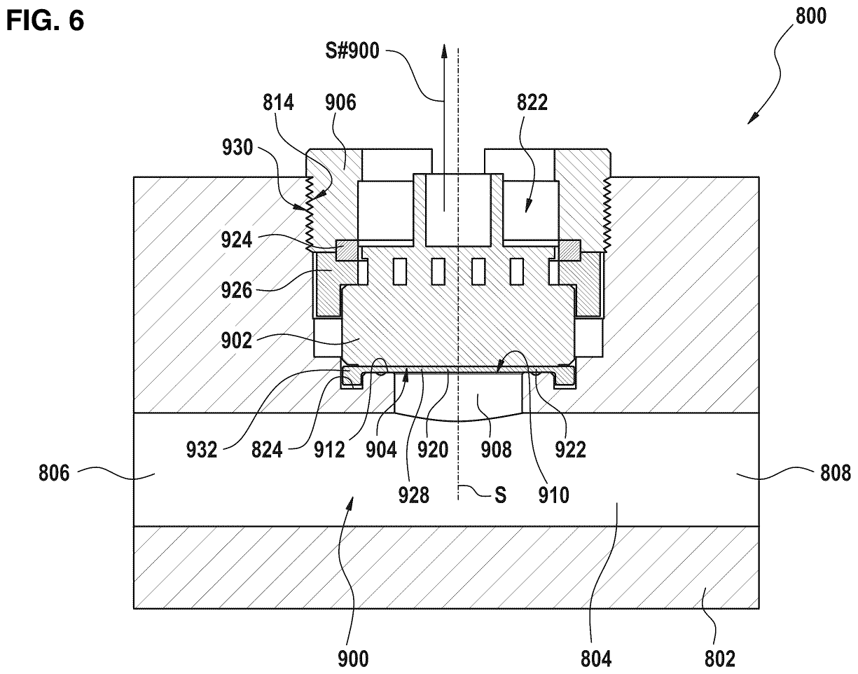

FIGS. 6, 8a, 9a, 10a each show a device for measuring a property of a process fluid;

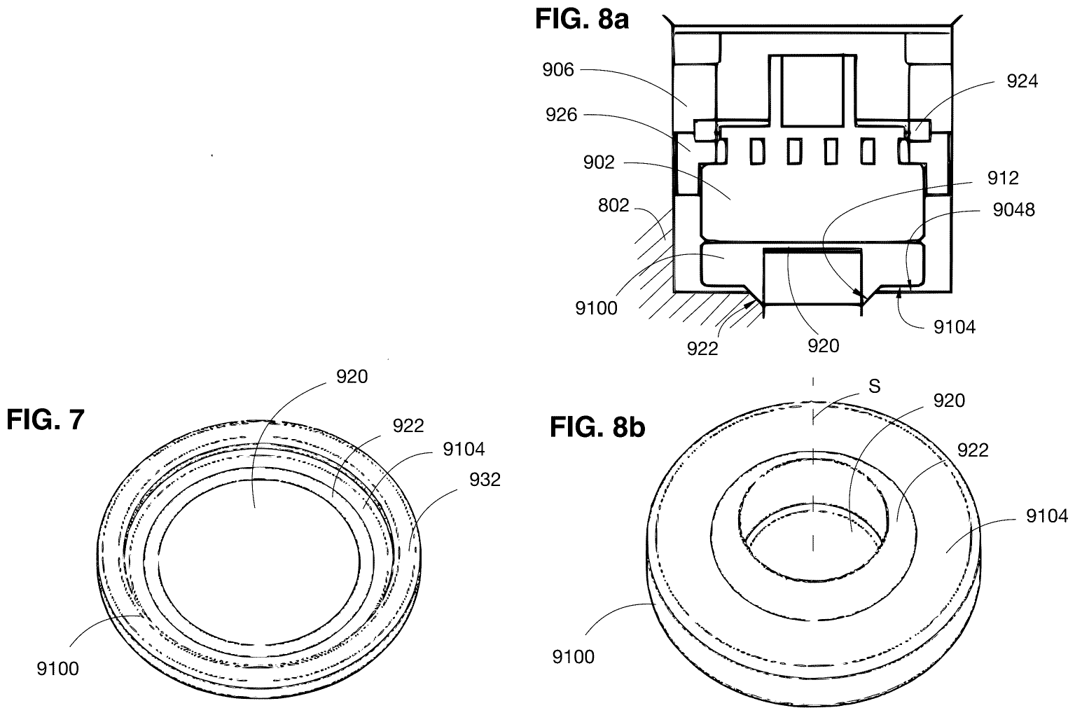

FIGS. 7, 8b, 9b, 10b each show a diaphragm element in a perspective view;

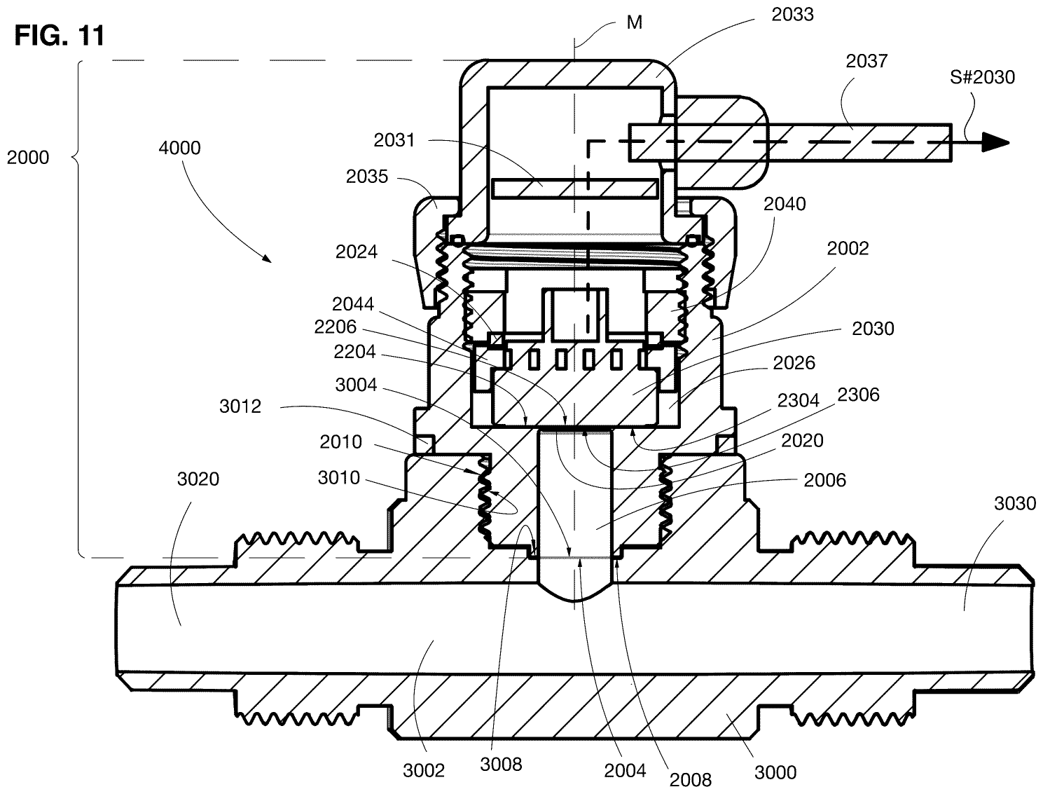

FIGS. 11, 15, 18, 23, 25 each show a sectional view of a device having a measuring device;

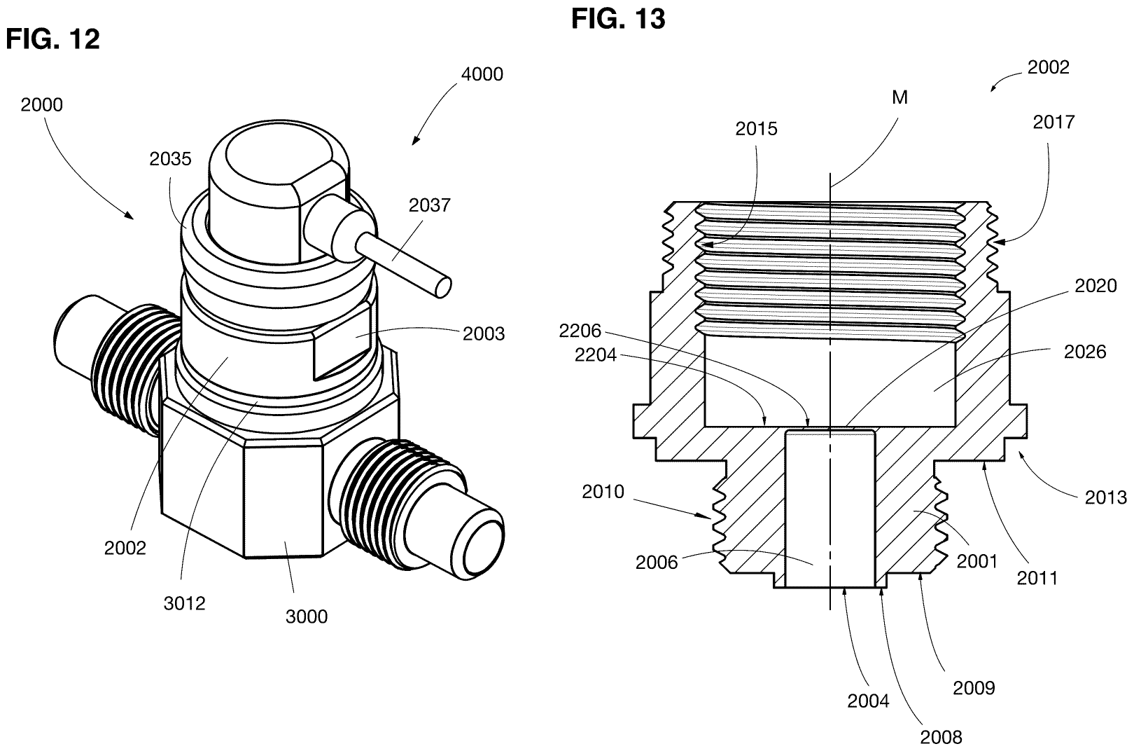

FIGS. 12, 16, 24 each show a perspective view of the device having the measuring device;

FIGS. 13, 17 each show a sectional view of a shell body of the measuring device;

FIG. 14 shows a body for arranging the measuring device of FIG. 11;

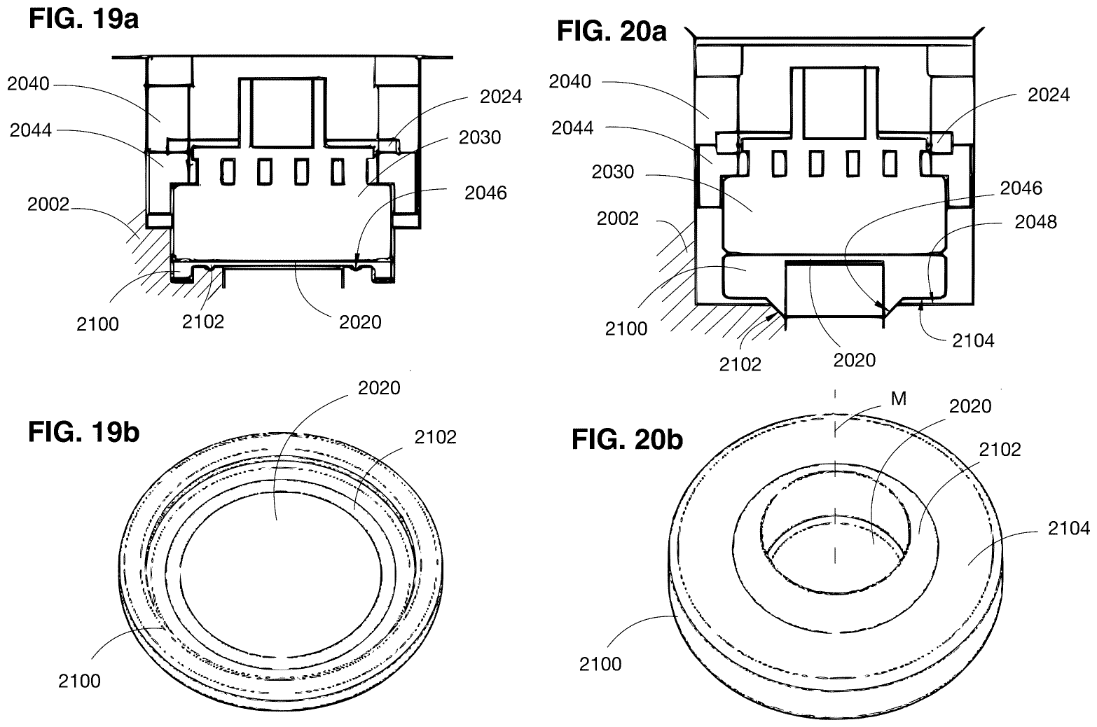

FIGS. 19a, 20a, 21a, 22a each show a detailed sectional view of the measuring device with a separately-designed diaphragm element; and

FIGS. 19b, 20b, 21b, 22b each show a perspective view of the diaphragm element.

FIG. 1 is a device 100 for adjusting or regulating a volumetric flow of a process fluid which can flow through the device 100. A one-piece body 102 comprises a fluid duct 104 which connects an inlet 106 and an outlet 108 to one another without further inlets or outlets. The fluid duct 104 comprises a measurement portion 110 which has a cross-sectional reduction 112 in the direction of flow F of the process fluid. The fluid duct 104 comprises an adjusting portion 140 arranged in the direction of flow F of the process fluid downstream of the measurement portion 110.

A first sensor 202 arranged at a first measuring point 200 of the measurement portion 110 is designed to generate a first sensor signal S #200, which characterizes a pressure of the process fluid in the region of the first measuring point 200. A second sensor 302 arranged at a second measuring point 300 of the measurement portion 110 is designed to generate a second sensor signal S #300, which characterizes a pressure of the process fluid in the region of the second measuring point 300. The second measuring point 300 is further away from the cross-sectional reduction 112 than the first measuring point 200. In an example (not shown), the first measuring point 200 is further away from the cross-sectional reduction 112 than the second measuring point 300 so as to optimally adapt the measuring arrangement to further measurement regions.

The measurement portion 110 is in particular free of measuring bodies between the first measuring point 200 and the second measuring point 300. The first and second measuring points 200, 300 are arranged in a region of a primary flow of the process fluid. An inner wall of a first sub-portion 120 of the measurement portion 110, which extends in the direction of flow F up to the cross-sectional reduction 112, has a first cross-section which is substantially constant with the exception of the first measuring point 200 along the longitudinal extension of the first sub-portion 120. An inner wall of a second sub-portion 130 of the measurement portion 110, which adjoins the cross-sectional reduction 112 in the direction of flow F, has a substantially constant second cross-section along the longitudinal extension of the second sub-portion 130 with the exception of the second measuring point 300. In the injection molding manufacturing process, the cross-section can also taper slightly due to the demolding in the direction of the inlet 106; however, this is not relevant for the measuring arrangement. In the case of bodies produced by machining, the cross-section can be constant.

The cross-sectional reduction 112 is arranged between the first and second measuring points 200, 300. The cross-sectional reduction 112 comprises either an annular surface perpendicular to the longitudinal axis of the measurement portion 110, or a frustoconical inner surface with the longitudinal axis of the measurement portion 110 as the cone axis. Of course, any other flow-optimized transition in the region of the cross-sectional reduction can also be used.

The corresponding sensor 202, 302 has a measuring surface 204, 304, which is in media contact in the example shown. The sensor 202, 302 is pressed in the direction of a fluid-conveying measurement chamber 208, 308 by means of a clamping means 206, 306. The measurement chamber 208, 308 branching off from the fluid duct has an opening 210, 310 which is surrounded by a contact surface 212, 312. An elastic element 214, 314, which is formed, for example, as a ring, is arranged and clamped between a lateral portion of the sensor 202, 302 and the contact surface 212, 312 of the body 102.

A valve arrangement 400 is configured to adjust a position of a shut-off body 442 which works together with a valve seat 142 within the adjusting portion 140 of the fluid duct 104 according to an activation signal S #400, by means of a drive 402, in particular by means of an electric motor. The position of the shut-off body 442 determines the volumetric flow of the process fluid through the device 100. The shut-off body 442 comprises a lateral clamped region 444 which merges into a diaphragm region 446. Within the diaphragm region 446, a shut-off portion 450 that can be moved along an adjusting axis SA adjoins the same, and has a cross-section perpendicular to the adjusting axis SA which widens in the direction of the valve seat 142. The shut-off portion 450 has a conical contour adapted to the measurement and control region, which contour allows an optimal flow behavior proportional to the adjusted position. Of course, differently shaped shut-off portions can also be used. The shut-off portion 450 is rigidly connected to a valve rod 452, which is moved by the drive 402. The drive 402 is connected to the body 102 via an intermediate piece 460.

A control device 500 is configured to determine the activation signal S #400 according to the first and the second sensor signal S #200, S #300. The control device 500 comprises a printed circuit board 580 which is fastened to the body 102 via a holder 582.

FIG. 2 shows a perspective view of the device 100. In contrast to FIG. 2, the device 100 is shown with a housing 303. A surface of the body 102 has an arrow 305 which indicates the direction of flow of the process fluid between the inlet 106 and the outlet 108. A display 590 is configured to display an actual through-flow as an indicator. The display 590 is, for example, also arranged in an analogous manner on the wide side of the housing 303 that is not visible. A detailed display can be realized, for example, via an app or a display on the upper narrow side of the housing, and shows numerical values of the through-flow.

FIG. 3 shows in schematic form the device 100 and an operating unit 600 with a user interface HMI. The control device 500 is configured to determine, by means of a determination unit 510, an actual volumetric flow Q according to the first sensor signal S #200 and according to the second sensor signal S #300. By means of a determination unit 520, the actual volumetric flow Q is compared with a target volumetric flow Q_set, and the activation signal S #400 is determined according to the comparison by means of the determination unit 520.

In a first example, the determination unit 510 determines the actual volumetric flow Q according to a pressure difference, which is determined according to the first and second sensor signals S #200, S #300, by means of a characteristic curve explained by way of example in FIG. 4. In another example, a temperature of the process fluid, which is provided by at least one further sensor signal T #200, T #300, is additionally used to determine the actual volumetric flow according to the pressure difference, by means of an associated characteristic diagram.

A wireless interface 530 is configured to transmit values of the actual volumetric flow Q and to receive values for the target volumetric flow Q_set. The wireless interface 530 is designed, for example, as a WLAN or Bluetooth interface, and provides the information generated by the control device 500 and the sensors. Furthermore, the wireless interface 530 accommodates information for configuring the device 100.

The sensor 202, 302 generates a further signal T #200, T #300 which characterizes a temperature of the process fluid. In a further example, the activation signal S #400 is additionally determined by means of the determination unit 520 according to the further signal T #200, T #300.

A further sensor 700 determines at least one additional sensor signal S #700, T #700, which represents a pressure, a temperature or a moisture within the housing of the device 100, and/or a temperature within the housing of the device 100, for the purpose of condition monitoring.

The display unit 590 visible from the outside is configured to display the determined actual volumetric flow Q, for example between 0% and 100%.

FIG. 4 shows a previously determined characteristic curve which is stored on the device in a data memory of the control device. By means of this characteristic curve, the determination unit 510 of FIG. 3 determines the actual volumetric flow Q according to the pressure difference Δp, furnished by a difference between the two pressures which are provided by means of the sensor signals of the two sensors 202, 302 of the previous figures.

FIG. 5 shows an example of the measuring point 200, 300, which in the present case is designed to be substantially rotationally symmetrical about an axis S. The measuring point 200, 300 comprises a measuring opening 210, 310, which is surrounded by a contact surface 212, 312 facing away from the fluid duct, wherein a clamping means 206, 306 supported on the body 102 presses the sensor 202, 302 in the direction of the contact surface 212, 312. A measuring diaphragm 220, 320 closes off the measuring opening 210, 310, wherein a clamping force generated by the clamping means 206, 306 supported on the body 102 clamps a lateral portion 222, 322 of the measuring diaphragm 220, 320 between a lateral portion of the sensor 202, 302 and the contact surface 212, 312. An elastic element 224, 324 is arranged between the clamping means 206, 306 and the measuring diaphragm 220, 320, in particular between the clamping means 206, 306 and the sensor 202, 302. A positioning piece 226, 326 is arranged in the force path between the clamping means 206, 306 and the sensor 202, 302 and rests against an outer contour of the sensor 202, 302 remote from the measuring diaphragm 220, 320—in particular accommodates this outer contour at least in portions.

The clamping piece 206, 306 is tightened to the bottom with a predefined maximum torque. The force predefined accordingly is directed via the positioning piece 226, 326 and the sensor 202, 302 into the lateral portion 222, 322. A wet-side surface of the lateral portion 222, 322 of the measuring diaphragm 220, 320 is pressed against the contact surface 212, 312 and thus seals the measuring points 200, 300. Thus, the sensor 202, 302 arranged on the dry side of the measuring diaphragm 220, 320 is protected from process fluid.

The elastic element 224, 324 is clamped between the clamping piece 206, 306 and the positioning piece 226, 326. On the side of the elastic element 224, 324, the clamping piece 206, 306 and the positioning piece 226, 326 abut one another, whereby the clamping piece 206, 306 directs its clamping force directly into the positioning piece 226, 326.

Alternatively, an air gap is present between the clamping piece 206, 306 and the positioning piece 226, 326, whereby the clamping piece 206, 306 directs its clamping force into the positioning piece 226, 326 via the elastic element 224, 324. If irregularities or unevenness occurs at the sealing point in the region of the measuring diaphragm 220, 320, the elastic element 224, 324 can compensate for this.

The positioning piece 226, 326 rests directly against the sensor 202, 302 and/or its housing and directs the clamping force into the sensor 202, 302. The sensor 202, 302 in turn rests directly against the measuring diaphragm 220, 320 and directs the clamping force into the lateral portion 222, 322.

The measuring diaphragm 220, 320 and the body 102 are produced from the same material, in particular from a thermoplastic such as polyhalogenated olefin, in particular from a polytetrafluoroethylene (PFTE). Alternatively, the body 102 can also be manufactured from stainless steel and the measuring diaphragm 220, 320 is produced from a thermoplastic such as polyhalogenated olefin, in particular from a polytetrafluoroethylene, PFTE.

Within the lateral portion 222, 322 of the measuring diaphragm 220, 320, the measuring diaphragm 220, 320 has a functional region 228, 328 which ensures that the property of the process fluid to be measured is passed on to the sensor 202, 302 and/or to its measuring surface 204, 304. For example, the functional region 228, 328 transmits a temperature and/or a pressure to the measuring surface 204, 304.

In order to arrange the sensor 202, 302, the body 102 has a receiving space 122, 132 for the sensor 202, 302 and its accessories in the region of the measuring point 200, 300. The contact surface 212, 312 is surrounded by a groove 124, 134 recessed relative to the contact surface 212, 312, into which groove a circumferential thickening 232, 332 of the measuring diaphragm 220, 320 engages. Proceeding from the groove 232, 332, the receiving space 122, 132 increases in a direction facing away from the measurement chamber 208, 308.

The clamping piece 206, 306 is designed as a clamping nut and has an external thread 230, 330 which engages in an internal thread 114 of the body 102 which is arranged in the receiving space 122, 132. Of course, the connection between the clamping piece and the body can also be designed differently.

FIG. 6 shows a device 800 which can be used independently of the device 100 of the preceding figures. The device 800 serves to measure at least one property of a process fluid. A single-piece or multi-piece body 802 comprises a fluid duct 804 arranged therein, which, for example, connects an inlet 806 and an outlet 808 to one another. However, the fluid duct 804 can also comprise branches. A measuring point 900 with a measuring opening 910 is located in the course of the fluid duct 804. The measuring opening 910 is surrounded by a contact surface 912 facing away from a measurement chamber 908 branching off from the fluid duct. A sensor 902, which is designed to generate a sensor signal S #900, which characterizes the property of the process fluid in the region of the measuring point 900, is arranged at the measuring point 900. A measuring diaphragm 920 closes off the measuring opening. A clamping means 906 supported on the body 802 presses the sensor 902 in the direction of the contact surface 912 and, via the directed force, clamps a lateral portion 922 of the measuring diaphragm 920 between the sensor 902 and the contact surface 922.

An elastic element 924 is arranged between the clamping means 906 and the measuring diaphragm 920, in particular between the clamping means 906 and the sensor 902.

A positioning piece 926, which rests against an outer contour of the sensor 902 facing away from the measuring diaphragm 920, in particular accommodates it, is arranged in the force path between the clamping means 906 and the sensor 902.

The clamping piece or clamping means 906 is tightened to bottom with a predefined maximum torque. The force predefined accordingly is directed via the positioning piece 926 and the sensor 902 into the lateral portion 922. A wet-side surface of the lateral portion 922 of the measuring diaphragm 920 is pressed against the contact surface 912 and thus seals the measuring point 900. The sensor 902 arranged on the dry side of the measuring diaphragm 920 is thus protected from process fluid.

The elastic element 924 is clamped between the clamping piece or clamping means 906 and the positioning piece 926. On the side of the elastic element 924, the clamping piece or clamping means 906 and the positioning piece 926 abut against one another, whereby the clamping piece or clamping means 906 directs its clamping force directly into the positioning piece 926. The positioning piece 926 rests directly against the sensor 902 or its housing and directs the clamping force into the sensor 902. The sensor 902 in turn rests directly against the measuring diaphragm 920 and directs the clamping force into the lateral portion 922.

The measuring diaphragm 920 and the body 802 are produced from the same material, in particular from a thermoplastic such as polyhalogenated olefin, in particular from a polytetrafluoroethylene (PFTE). Alternatively, the body 802 can also be made of stainless steel and the measuring diaphragm 920 is produced from a thermoplastic such as polyhalogenated olefin, in particular from a polytetrafluoroethylene, PFTE.

Within the lateral portion 922 of the measuring diaphragm 920, the measuring diaphragm 920 has a functional region 928 which ensures that the property of the process fluid to be measured is passed on to the sensor 902 or to its measuring surface 904. For example, the functional region 928 transmits a temperature and/or a pressure to the measuring surface 904.

In order to arrange the sensor 902, the body 802 has a receiving space 822 for the sensor 902 and its accessories in the region of the measuring point 900. The contact surface 912 is surrounded by a groove 824 recessed relative to the contact surface 912, into which groove a circumferential thickening 932 of the measuring diaphragm 920 engages. Proceeding from the groove 824, the receiving space 822 increases in a direction facing away from the measurement chamber 908.

The clamping piece 906 is designed as a clamping nut and has an external thread 930 which engages into an internal thread 814 of the body 802 which is arranged in the receiving space 822. Of course, the connection between the clamping piece and the body can also be designed differently.

FIG. 7 in conjunction with FIG. 6 shows a perspective representation of a diaphragm element 9100 which is used in FIG. 6. This type of media separation by the separately designed diaphragm element 9100 can also be transferred to the flow regulator or the device 100 from the previous figures. The wet side shown of the diaphragm element 9100 comprises the lateral contact surface 922, which surrounds the measuring diaphragm 920 or its surface delimiting a fluid chamber. The thickening 932 raised on the wet side is arranged radially outside the lateral portion 922, which can also be referred to as the inner sealing portion. The thickening 932 serves, for example, to center or position the diaphragm element 9100.

A device 800 is shown, wherein a diaphragm element 9100 separate from the body 802 comprises the measuring diaphragm 920, and wherein the diaphragm element 9100 comprises a sealing portion with a contact surface 922 which is pressed against a cooperating sealing portion with the contact surface 912 of the body 802 by means of a clamping force applied by the clamping piece or clamping means 906.

The sealing portion of the diaphragm element 9100 substantially follows an imaginary continuation of the measuring diaphragm 920. It is shown that the sealing portion of the diaphragm element 9100 runs perpendicular to the central longitudinal axis S of the device 800.

An outer portion 9104 of the diaphragm element 9100 surrounding the sealing portion runs perpendicular to the central longitudinal axis S. The sealing portion absorbs the clamping force from the sensor 902 and directs it into the contact surface 912, and thus the cooperating sealing portion, via the contact surface 922.

A cooperating portion 9048 of the body 802 surrounding the cooperating sealing portion with its contact surface 912 is spaced apart from the portion 9104 surrounding the sealing portion. For example, it is shown that the sealing portion of the diaphragm element 9100 and the measuring diaphragm 920 of the diaphragm element 9100 are spaced apart from one another along a central longitudinal axis S of the sensor 902.

FIG. 8a shows an example of the body 802 and the diaphragm element 2100. It is shown that the sealing portion of the diaphragm element 9100 in the direction of an opening of the diaphragm element 9100 has a taper or a widening, in particular follows a frustoconical surface, at least in portions.

FIG. 8b shows the sealing element 9100 of FIG. 8a. Due to the spacing of the measuring diaphragm 920 and contact surface 922 for the sealing, a fluid chamber is created, which in the present case is delimited by cylindrical shell-shaped inner surfaces of the diaphragm element 9100.

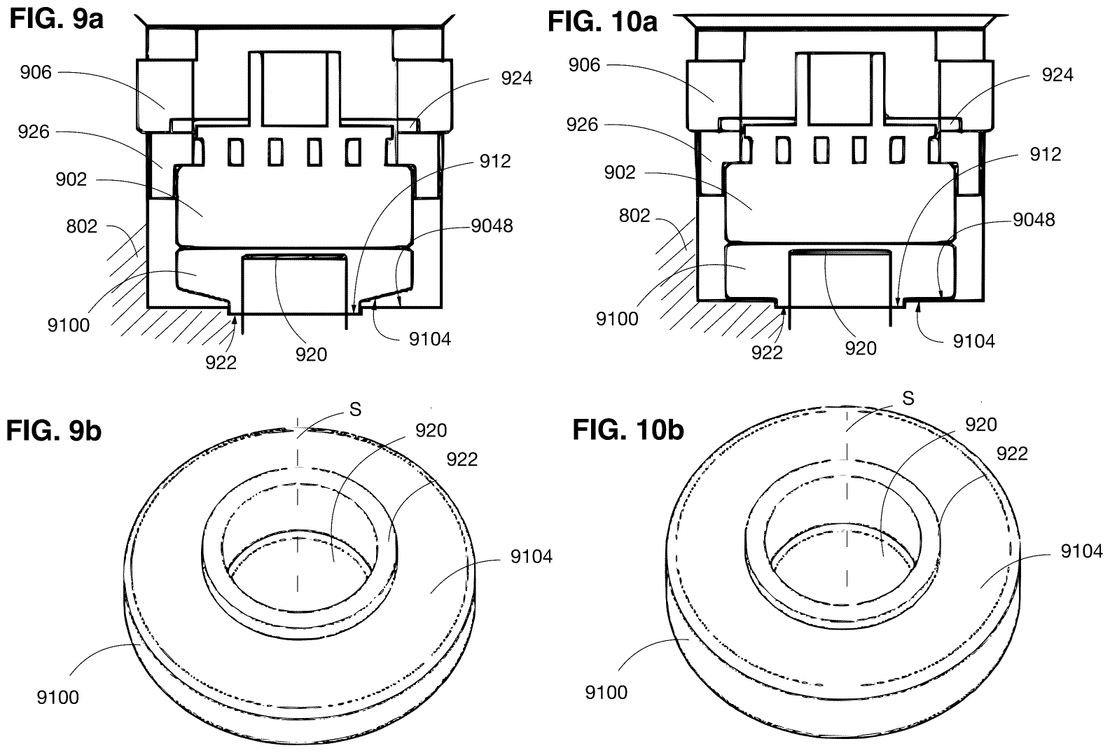

FIGS. 9a and 9b show a further example of the body 802 and of the diaphragm element 9100. In contrast to the example of FIGS. 8a, 8b, the contact surface 922 of the sealing portion is perpendicular to the central longitudinal axis S. An outer portion 9104 surrounding the inner sealing portion tapers in the direction of the inner sealing portion, and, in the example, follows a frustoconical surface.

FIGS. 10a and 10b show an example of the body 802 and the diaphragm element 9100. The contact surface 922 of the sealing portion of the diaphragm element 9100 and the surface of the surrounding portion 9104 are spaced apart from one another, and both run perpendicular to the central longitudinal axis S. The surfaces of the surrounding portion 9104 and of the cooperating portion 9048 are spaced apart from one another. The diaphragm element 9100 thus has a wet-side step shape.

Of course, the wet-side contour of the diaphragm element and the cooperating contour of the body 802 can also be mirrored in a perpendicular plane of the central longitudinal axis S. For example, the measuring opening of the body can be surrounded by a raised circular ring onto which a recessed circular ring of the diaphragm element 9100 presses.

FIG. 11 shows a measuring device 2000 received in a body 3000. The measuring device 2000 can also be referred to as a measuring sleeve or sensor carrier. The measuring device 2000 comprises: a shell body 2002 having an opening 2004 which leads into a fluid chamber 2006 of the measuring device 2000, and having a sealing portion 2008 surrounding the opening 2004; an interface 2010 which interface is configured to be supported on a cooperating interface 3010 of a body 3000 which is designed to provide process fluid, and to press the sealing portion 2008 of the shell body 2002 against a cooperating sealing portion 3008 of the body 3000; a measuring diaphragm 2020 which separates the fluid chamber 2006 from a measurement chamber 2026 of the measuring device 2000; and a sensor device arranged at least partially inside the measurement chamber 2026, comprising a sensor 2030 which lies against the measuring diaphragm 2020, wherein the sensor device is configured to provide a signal S #2030 which represents a fluid pressure in the fluid chamber 2006 and/or a different property of the process fluid, such as temperature. It is shown that the measuring diaphragm 2020 and the shell body 2002 are integrally connected to one another.

The fluid chamber 2006 is delimited by the shell body 2002. In particular, the fluid chamber 2006 is delimited by the measuring diaphragm 2020 and a cylindrical shell-shaped inner wall of the shell body 2002.

The drawing shows that the measuring device 2000 comprises a clamping means 2040 which is supported on the shell body 2002, and which presses the sensor 2030 against the measuring diaphragm 2020.

In a force path between the clamping means 2040 and the measuring diaphragm 2020, In particular between the clamping means 2040 and the sensor 2030, an elastic element 2024 is arranged under pressure—for example, an elastomer ring.

A positioning piece 2044 designed in particular rigidly is tolerated with respect to an inner contour of the measurement chamber 2026, and rests against an outer contour of the sensor 2030 facing away from the measuring diaphragm 2020, whereby the position of the sensor 2030 perpendicular to the central longitudinal axis M is defined in relation to the shell body 2002. The positioning piece 2044 is arranged between the clamping means 2040 and the sensor 2030. The elastic element 2024 is arranged between the clamping means 2040 and the positioning piece 2044. The clamping means 2040 comprises an external thread which engages in an internal thread of the shell body 2002 and thus presses the sensor 2030 in the direction of the measuring diaphragm 2020.

The measuring diaphragm 2020 and the opening 2004 of the shell body 2002 leading into the fluid chamber 2006 are spaced apart from one another along the central longitudinal axis M of the shell body 2002, in particular to by least a quarter of the diameter of the opening 2004.

For example, it is shown that a contact surface 2204 of the shell body 2002, for contacting an outer contact surface 2304 of the sensor 2030, surrounds a measuring surface 2206 of the measuring diaphragm 2020 for contacting an inner measuring surface 2306 of the sensor 2030, wherein the contact surface 2204 and the measuring surface 2206 lie in the same imaginary plane. The measuring surface 2206 and the contact surface 2204 for the sensor run perpendicular to the central longitudinal axis M.

The measuring diaphragm 2020 and the shell body 2002 are produced from the same material, in particular from a polyhalogenated olefin, in particular from a polytetrafluoroethylene, PFTE, and/or a perfluoroalkoxy, PFA.

The sealing portion 2008 and the cooperating sealing portion 2008 are in the present case circular ring-shaped.

The shell body 2002, the interface 2010, the measuring diaphragm 2020, and the sensor device 2026 lie on the same central longitudinal axis M and are substantially rotationally symmetrical.

The interface 2010 lies radially outside an imaginary cylindrical extension of the opening 2004 and radially outside of the sealing portion 2008.

In the present case, the interface 2010 is designed as an external thread of the shell body 2002. The external thread engages in an internal thread of the body 3000 designed as the cooperating interface 3010.

By means of a predetermined tightening torque, the shell body 2002 is fixed to the body 3000, and the sealing portion 2008 is pressed against the cooperating sealing portion 3008 with a sealing force so that the fluid chamber 2006 and the interior of the body 3000 are sealed relative to an exterior. The interface 2010 fixes the measuring device 2000 rigidly to the body 3000.

Radially outside the interface 2010, an elastomer element 3012, for example an elastomeric O-ring, is located between the body 3000 and the measuring device 2000.

The cooperating sealing portion 3008 surrounds a measuring opening 3004 of the body 3000. The cooperating sealing portion 3008 is surrounded by a leakage space which is formed by the body 3000 and the measuring device 2000. The leakage space is connected to the exterior space (in a manner not shown) via a leakage line in order to display a lack of tightness.

A measuring electronics 2031 is arranged in a cap 2033 of the measuring device 2000. The cap 2033 terminates the measuring device 2000 distally and is secured on the measuring body 2002 by means of a union nut 2035. The signal S #2030 is conveyed via a line 2037. Alternatively, a wireless transmission of the signal S #2030 can also take place.

Shown is a device 4000 comprising: the measuring device 2000; and the body 3000 with a fluid duct 3002 arranged therein and at least one—in particular, multiple—process fluid connections 3020, 3030, wherein a measuring point located in the course of the fluid duct 3002 has a measuring opening 3004, wherein the measuring opening 3004 is surrounded by a cooperating sealing portion 3008 for the sealing portion 2008 of the shell body 2002, and wherein the body 3000 has a cooperating interface 3010 for the interface 2010 of the measuring device 2000. The cooperating interface 3010 is arranged radially outside of the sealing portion 2008. The body 3000 provides the cooperating interface via a receiving bushing in which the measuring device 2000 is received.

FIG. 12 shows the arrangement of FIG. 11 in a perspective view. Via an engagement contour 2003, the measuring device 2000 can be screwed into or detached from the body 3000 by means of a tool. A rotational position of the protruding conduit 2037 can be changed by unscrewing and fixing the union nut 2035 on the cap.

FIG. 13 shows a section of the shell body 2002 from the arrangement according to FIGS. 11 and 12. A projection 2001 of the shell body 2002 arranged proximally with respect to the body 3000 (not shown) comprises the sealing portion 2008. The sealing portion 2008 runs parallel to the central longitudinal axis M of the shell body 2002 and is designed to be raised relative to a surrounding portion 2009 of the projection 2001. The surrounding portion 2009 of the projection 2001 likewise runs perpendicular to the central longitudinal axis. The external thread 2010 adjoins the surrounding portion 2009. The projection 2001 projects from an annular surface 2011 which runs perpendicular to the central longitudinal axis M.

An annular recess 2013 adjoins the surface 2011 and is provided for receiving the elastomer element 3012 of FIGS. 11 and 12.

The diaphragm 2020 integrally formed with the shell body 2002 separates the measurement chamber 2026 from the fluid chamber 2006. On the dry space side, the measuring diaphragm 2020 terminates in a continuous surface with the surrounding contact surface 2204. At least in portions, the transition between the measuring diaphragm 2020 and the main body of the shell body 2002 follows a toroidal surface, at least in portions.

The measurement chamber 2026 has a larger diameter than the fluid chamber. An internal thread 2015 within the measurement chamber 2026 serves to receive an external thread of the clamping means 2040 (not shown). A distal external thread 2017 serves to receive an internal thread of the union nut 2035 (not shown).

FIG. 14 shows the body 3000 for receiving the measuring device 2000. A raised receiving portion 3001 exposes access to the cooperating interface and to the measuring opening 3004 via a receiving opening 3003. The measuring opening 3004 is surrounded by the cooperating sealing portion 3008. The measuring opening 3004 leads into the fluid duct connecting the fluid connections 3020 and 3030.

The body 3000 can of course also have a different design and in particular comprise valve units. For example, the body 3000 is a valve body or a valve block. In another example, the body 3000 has only a single fluid connection which leads to the measuring opening 3004.

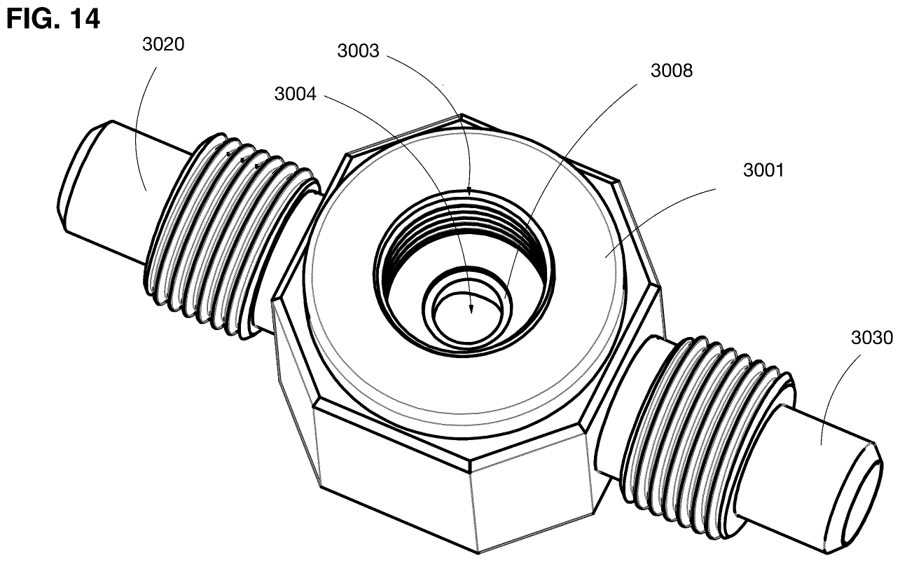

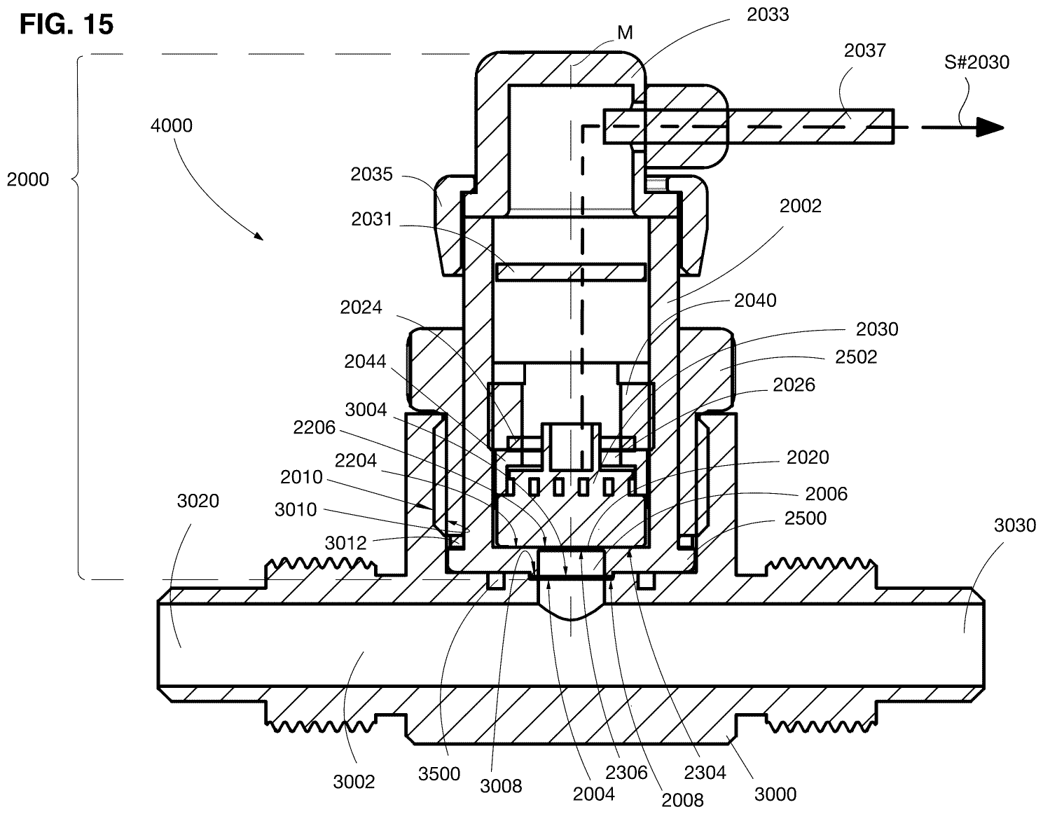

In contrast to FIG. 11, FIG. 15 shows another example of the body 3000 and the measuring device 2000. The measuring device 2000 comprises a proximal, circular ring-shaped collar 2500 which projects outwardly from a portion of the shell body 2002 in the form of a cylindrical shell. The collar 2500 is part of the proximal end of the measuring device 2000 received within a receiving opening of the body 3000. A union nut 2502 comprises the external thread 2010, which engages in the internal thread of the cooperating interface 3010 of the body 3000. The union nut 2502 has an engagement portion accessible from the outside for engaging a tool. The union nut 2502 is screwed into the body 3000 via a directed torque, and directs a clamping force into the collar 2500 of the shell body 2002 via the elastomer element 3012. The elastomer element 3012 is arranged between the union nut 2502 and the outer collar and/or collar 2500 of the shell body 2002. The proximal end of the shell body 2002 is contoured in such a way that the applied clamping force is directed into the cooperating sealing portion 3008 of the body 3000 via the sealing portion 2008. For this purpose, the portions of the shell body 2002 lying radially outside the portions 2008 and 3008 and of the body 3000 receiving the shell body 2002 are spaced apart from one another.

In contrast to FIG. 1, the interface on the measuring device 2000 is provided by the union nut 2502 and by the external thread 2010 arranged thereon and the outer collar and/or collar 2500.

It is shown that the shell body 2002 and the body 3000 delimit, at least in portions, a leakage duct 3500 which leads into an exterior of the device 4000. The leakage duct 3500 annularly surrounds the sealing portion 2008.

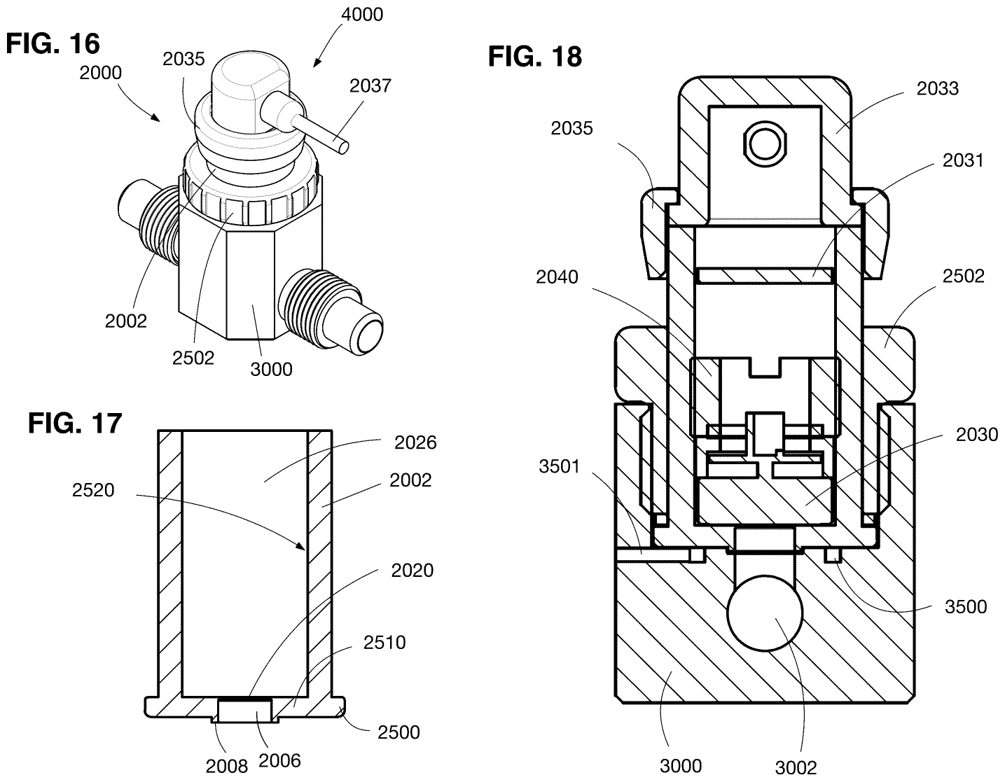

FIG. 16 shows the arrangement 4000 of FIG. 15 in a perspective view.

FIG. 17 shows the shell body 2002 of the measuring device 2000 of FIGS. 15 and 16. The shell body 2002 is pot-like. A base 2510 comprises, radially inward, the measuring diaphragm 2020, which is formed integrally with the shell body 2002, and, radially outward, the collar 2500. A cylindrical shell-shaped wall extends from the base 2510, providing at least one internal thread 2520 for the external thread of the clamping means 2040 (not shown).

FIG. 18 shows the device 4000 in a section perpendicular to the course of the fluid duct 3002. In particular, it is shown how the leakage duct 3500 is guided to the exterior with a puncture 3501.

The following figures show alternatives to the one-piece design of the measuring diaphragm 2020 and the shell body 2002.

FIGS. 19a and 19b show an example of a diaphragm element 2100—separated from the shell body 2002—which comprises the measuring diaphragm 920. The diaphragm element 2100 comprises a sealing portion 2102 with a contact surface which is pressed against a cooperating sealing portion 2046 of the shell body 2002 by means of a clamping force applied by the clamping piece or clamping means 906. In the example, it is shown that the sealing portion 2102 of the diaphragm element 2100 substantially follows an imaginary continuation of the measuring diaphragm 2020. It is shown that the sealing portion 2102 of the diaphragm element 2100 runs perpendicular to the central longitudinal axis M of the measuring device 2000.

The figure shows that a portion 2104 of the diaphragm element 2100 arranged radially outside of the sealing portion 2102 runs perpendicular to the central longitudinal axis M. The surrounding portion 2104 forms a thickening surrounding the measuring diaphragm 2020, which thickening absorbs the clamping force of the sensor 2030 and directs it into the mating surface of the cooperating sealing portion 2046 via the sealing portion 2102.

It is shown that a cooperating portion 2048 of the shell body 2002 surrounding the cooperating sealing portion 2046 is spaced apart from the portion 2104 surrounding the sealing portion 2102.

In the example, it is shown that the sealing portion 2102 of the diaphragm element 2100 and the measuring diaphragm 2020 of the diaphragm element 2100 are spaced apart from one another along the central longitudinal axis M of the shell body 2002.

It is shown that a diaphragm element 2100 separate from the shell body 2002 comprises the measuring diaphragm 2020, and the diaphragm element 2100 comprises a sealing portion 2102 which is pressed against a cooperating sealing portion 2046 of the shell body 2002 by means of a clamping force applied by the clamping element 2040.

It is shown that the sealing portion 2102 of the diaphragm element 2100 and the measuring diaphragm 2020 of the diaphragm element 2100 are spaced apart from one another along the central longitudinal axis M of the shell body 2002.

The example shown relates to the fact that the sealing portion 2102 of the diaphragm element 2100 substantially follows an imaginary continuation of the measuring diaphragm 2020.

It is shown that the sealing portion 2102 of the diaphragm element 2100 runs perpendicular to the central longitudinal axis S of the shell body 2002.

The wet side of the diaphragm element 2100 shown in FIG. 19b comprises the lateral contact surface of the sealing portion 2102, which surrounds the measuring diaphragm 2020 or its surface delimiting a fluid chamber. A thickening 2104 raised on the wet side is arranged radially outside the lateral portion with the contact surface of the sealing portion 2102, which can also be referred to as the inner sealing portion. The thickening 2104 serves, for example, for centering or positioning the diaphragm element 2100, by virtue of the fact that the thickening 2104 engages in a corresponding annular groove of the shell body 2002.

FIG. 20a shows an example of the shell body 2002 and the diaphragm element 2100 arranged therein. For example, it is shown that the sealing portion 2102 of the diaphragm element 2100 has a taper or a widening, in particular following a frustoconical surface, in the direction of an opening of the diaphragm element 2100. The sealing portion 2102 of the diaphragm element 2100 follows a frustoconical surface.

FIG. 20b shows the sealing element 2100 of FIG. 20a. The spacing of the measuring diaphragm 2020 and the contact surface of the sealing portion 2102 creates the fluid chamber, in the present case delimited by cylindrical shell-shaped inner surfaces of the diaphragm element 2100, forming a blind hole.

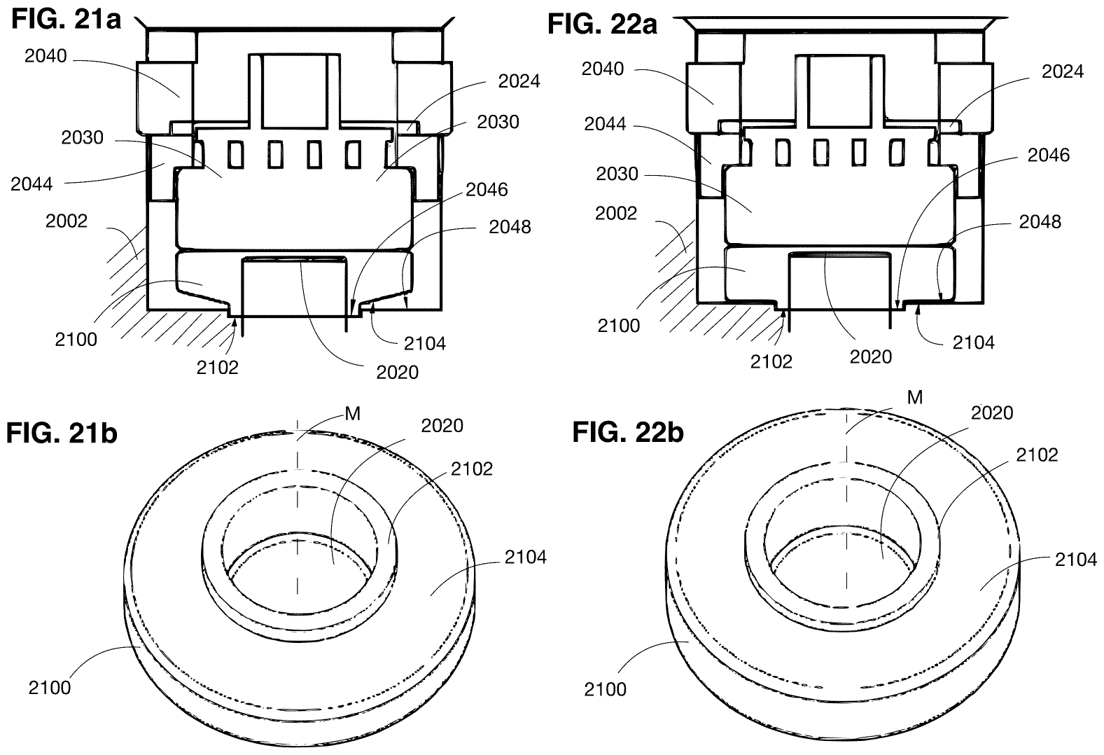

FIGS. 21a and 21b show a further example of the shell body 2002 and of the diaphragm element 2100. In contrast to the example of FIGS. 20a, 20b, the contact surface of the sealing portion 2102 is perpendicular to the central longitudinal axis M. In the example, it is shown that an outer portion 2104 surrounding the inner sealing portion tapers in the direction of the inner sealing portion 2102, in particular following a frustoconical surface.

FIGS. 20a and 20b show an example of the shell body 2002 and the diaphragm element 2100. The contact surface of the sealing portion 2102 of the diaphragm element 2100 and the surface of the surrounding portion 2104 are spaced apart from one another, and both run perpendicular to the central longitudinal axis M. The surfaces of the surrounding portion 2104 and of the cooperating portion 2048 are spaced apart from one another. The diaphragm element 2100 thus has a wet-side step shape.

It is shown that an outer portion 2104 surrounding the sealing portion 2102 runs perpendicular to the central longitudinal axis M.

In the example, it is shown that a cooperating portion 2048 of the shell body 2002 opposite the surrounding portion 2104 and surrounding the cooperating sealing portion 2046 is spaced from the surrounding portion 2104.

It is shown that an outer portion 2104 surrounding the inner sealing portion 2102 tapers in the direction of the inner sealing portion 2102, in particular following a frustoconical surface.

Of course, the wet-side contour of the diaphragm element 2100 and the mating contour of the shell body 2002 can also be mirrored in a perpendicular plane of the central longitudinal axis M. For example, the opening of the shell body can be surrounded by a raised circular ring onto which a recessed circular ring of the diaphragm element 2100 presses as a sealing portion 2102.

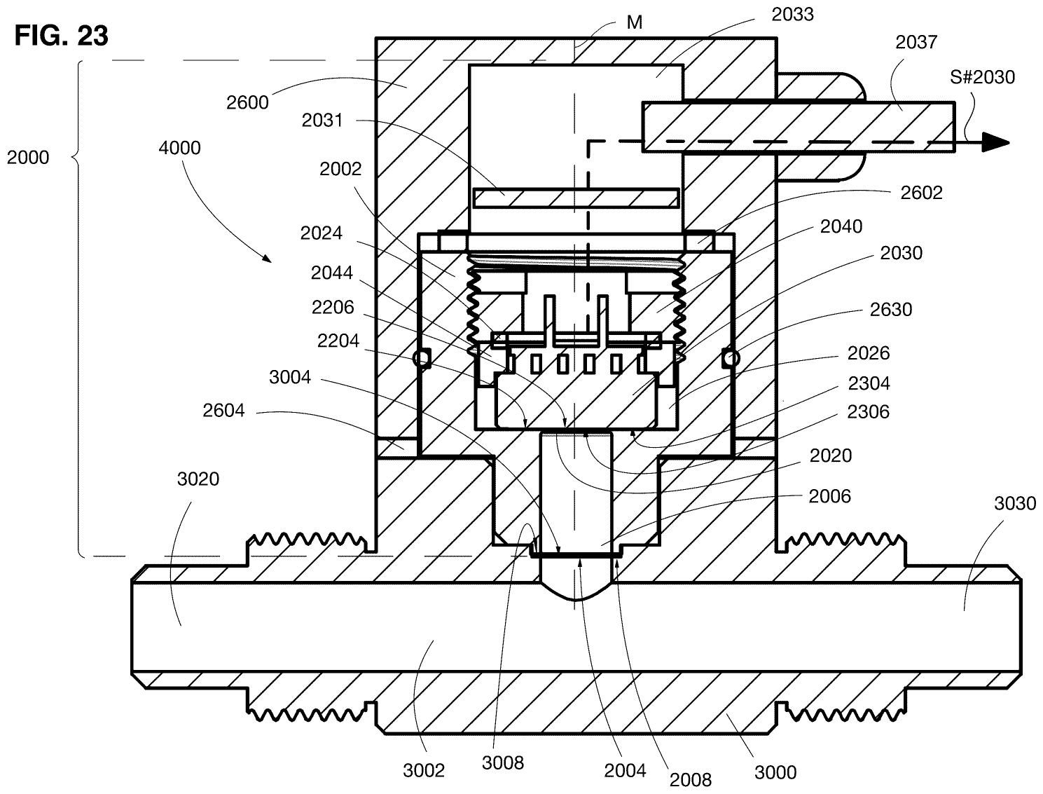

FIG. 23 shows a longitudinal section of an example of the device 4000. In contrast to the previous examples, the measuring device 2000 comprises a housing 2600 partially surrounding the shell body 2002. In particular, the portion of the measuring device 2000 facing away from the body 3000 receiving the measuring device 2000 is accommodated by the housing 2600.

In contrast to the example of FIG. 11, the similarly designed shell body 2020 does not comprise an external thread facing the body 3000. Rather, the housing 2600 is used as part of the mechanical interface.

The housing 2600 is fastened to the body 3000 by means of the interface 2010 (not shown in FIG. 23). The housing 2600 is thus supported on the body 3000 and presses onto the shell body 2002 via an elastomer element 2602 arranged between the housing 2600 and the shell body 2002. The sealing portion 2008 of the shell body 2002 presses against the cooperating sealing portion 3008 of the body 3000, whereby the device 4000 is sealed to the outside.

An elastic element 2604 is arranged between the body 3000 and the housing 2600.

As an alternative to the shell body 2002 shown, with integrated measuring diaphragm 2020, a measuring sleeve 2002 with a separately designed diaphragm element 2100 can also be used—according to an example of FIGS. 19a-22b.

An elastic O-ring 2630 is arranged between the shell body 2002 and the housing 2600, and securely fixes the shell body 2002 to the housing 2600.

The portion of the shell body 2002 projecting into the body 3000 is designed to be thread-free, which is why no torsional forces act toward the central longitudinal axis M, in particular in the region of the measuring diaphragm 2020. Advantageously, the measuring diaphragm 2020 is protected from damage.

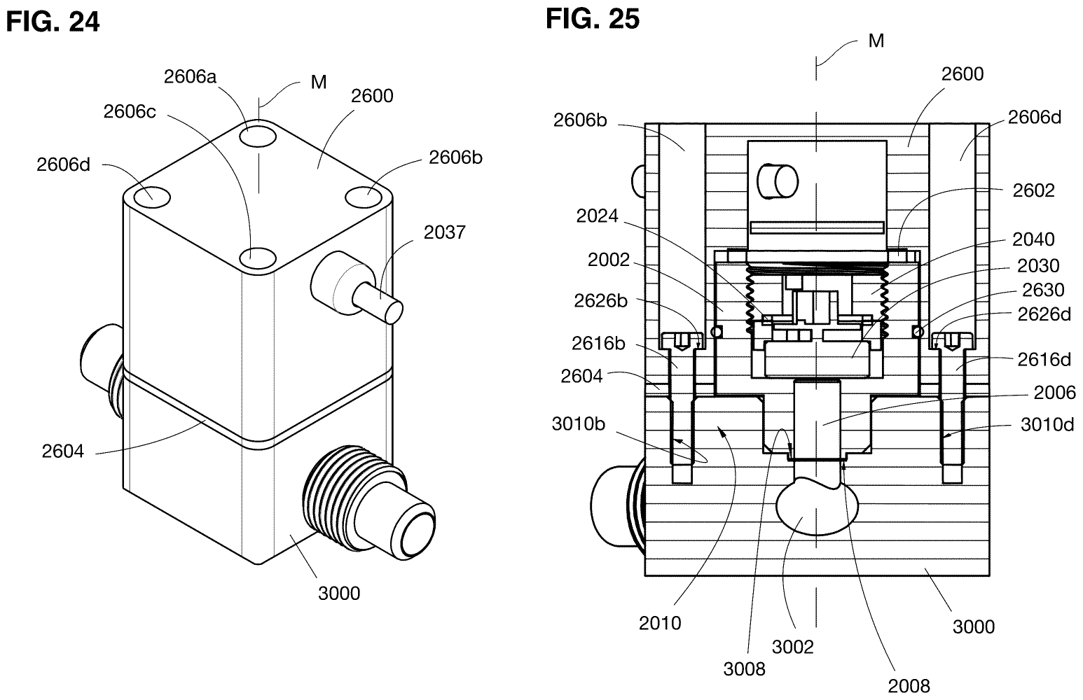

FIG. 24 shows a perspective view of the device 4000. The housing 2600 follows a rectangle or square in a section perpendicular to the central longitudinal axis M. Passage openings 2606a-d run, proceeding from the openings shown, parallel to the central longitudinal axis, up to openings on the side of the body 3000.

FIG. 25 shows a further section of the example of the device 4000 of FIGS. 23 and 24, through the through-openings 260b and 2606d. The through-openings 2606a-d are designed in a stepped manner, so that a screw head of a corresponding screw 2616a-d rests against a corresponding contact surface 2626a a-d facing away from the body 3000. The corresponding screw 2616a-d is thus inserted into the associated through-opening 2606b and screwed into a mating thread designed as a cooperating interface 3010b. As a result, the housing 2600 presses the shell body 2002 with its sealing portion 2008 onto the cooperating sealing portion 3008.

The housing 2600 comprises an inner, in particular annular, contact surface 2610 which presses against the shell body 2002 on the elastomeric element 2602.

The housing 2600 and the screws 2616a-d constitute the interface 2010 of the measuring device 2000. The housing 2600 is supported on the body 3000 by means of the screws 2616a-d, and clamps the shell body 2002 between itself and the body 3000.

1-63. (canceled)

64. A measuring device, comprising:
a sleeve body having an opening which leads into a fluid chamber of the measuring device, and having a sealing portion surrounding the opening;
an interface which is configured to be supported on a cooperating interface of a body which is designed to provide process fluid, and to press the sealing portion of the sleeve body against a cooperating sealing portion of the body;
a measuring diaphragm which separates the fluid chamber from a measurement chamber of the measuring device; and
a sensor device arranged at least partially within the measurement chamber, comprising a sensor which rests against the measuring diaphragm, wherein the sensor device is configured to provide a signal which represents a property of the process fluid in the fluid chamber.

65. The measuring device according to claim 64, wherein the measuring device comprises: a clamp which is supported on the sleeve body and which presses the sensor against the measuring diaphragm.

66. The measuring device according to claim 65, wherein an elastic element is arranged under pressure in a force path between the clamp and the measuring diaphragm, in particular between the clamp and the sensor.

67. The measuring device according to claim 65, wherein a rigid, positioning piece fills the volume of an inner contour of the measurement chamber at least in portions, and rests against an outer contour of the sensor facing away from the measuring diaphragm.

68. The measuring device according to claim 67, wherein the positioning piece is arranged between a clamp and the sensor.

69. The measuring device according to claim 67, wherein the elastic element is arranged between a clamp and the positioning piece.

70. The measuring device according to claim 64, wherein the measuring diaphragm and the sleeve body are integrally connected to each other.

71. The measuring device according to claim 70, wherein a contact surface of the sleeve body, for contacting an outer contact surface of the sensor, surrounds a measuring surface of the measuring diaphragm for contacting an inner measuring surface of the sensor, and wherein the contact surface and the measuring surface are located in the same imaginary plane.

72. The measuring device according to claim 64, wherein a diaphragm element separate from the sleeve body comprises the measuring diaphragm, and wherein the diaphragm element comprises a sealing portion which is pressed against a cooperating sealing portion of the sleeve body by a clamping force applied by the clamp, wherein the sealing portion of the diaphragm element and the measuring diaphragm of the diaphragm element are spaced apart from one another along the central longitudinal axis (M) of the sleeve body.

73. The measuring device according to claim 64, wherein the sealing portion of the diaphragm element follows a frustoconical surface.

74. The measuring device according to claim 64, wherein the sealing portion of the diaphragm element has, at least in portions, a taper or a widening, in particular following a frustoconical surface, in the direction of an opening of the diaphragm element.

75. The measuring device according to claim 64, wherein a cooperating portion of the sleeve body surrounding the cooperating sealing portion is spaced apart from the portion surrounding the sealing portion.

76. The measuring device according to claim 64, wherein the sealing portion of the diaphragm element and the measuring diaphragm of the diaphragm element are spaced apart from one another along the central longitudinal axis (M) of the sleeve body.

77. The measuring device according to claim 64, wherein an outer portion surrounding the inner sealing portion tapers in the direction of the inner sealing portion, in particular following a frustoconical surface.

78. The measuring device according to claim 64, wherein the measuring diaphragm, in particular the diaphragm element, and the sleeve body are produced from the same material, in particular from a polyhalogenated olefin, in particular from a polytetrafluoroethylene (PFTE), and/or a perfluoroalkoxy, PFA.
